(19) United States
(12) Patent Application Publication
(10) Pub. No.: US 2023/0380658 A1
(43) Pub. Date: Nov. 30, 2023

(54) STRUCTURE FOR DRYER DUCT

(71) Applicant: Chengchuan LIN, Fujian (CN)

(72) Inventor: Chengchuan LIN, Fujian (CN)

(21) Appl. No.: 18/231,802

(22) Filed: Aug. 9, 2023

(30) Foreign Application Priority Data
Jan. 9, 2023 (CN) 202320058372.4

(51) Int. Cl. A47L 23/20; F24F 7/04

(52) U.S. Cl. CPC A47L 23/205; F24F 7/04

(57) ABSTRACT

An improved structure for a dryer duct, in which a center of the duct is an air intake channel; a top surface of the duct extends forward to form a top baffle; the top baffle is positioned above the air intake channel, and an air outlet of the air intake channel is positioned on an outer wall of the air intake channel; the air outlet is positioned below the top baffle. Dripping water is prevented from flowing into the air intake channel of the duct while the dryer is working, thereby avoiding short circuits or electrical leakage of the internal electrical components and ensuring safety and proper functioning of the dryer.

### BACKGROUND OF THE INVENTION

The present invention relates to the technical field of drying devices, and in particular to an improved structure for a dryer duct.

In daily life, shoes often become damp due to sweat, and in rainy or snowy weather, they are more prone to getting soaked or damp. However, achieving dryness inside waterlogged or damp shoes through natural air drying takes a considerable amount of time. Therefore, people have developed the dryer. For some boots worn in cold weather, they have taller calf extension and fur lining inside, making it even more challenging to dry the interior after it gets damp.

In an existing dryer, a duct for the outlet of hot air is provided thereon, and a plurality of air outlets are formed on the top of the duct. The dryer dries a shoe by placing the shoe over the duct. However, some of the existing dryer ducts have air outlets thereof formed at the top of the duct. According to customer feedback, these dryers cannot effectively dry shoes that have been washed (for safety reasons, most dryers on the market are unable to dry shoes dampened with a significant amount of water). When items to be dried contain a significant amount of water, especially shoes that have just been washed, dripping water exists during the drying process, or water vapor may be condensed into dripping water in case of hot drying. These dripping water falls into the air channel through the air outlets and interferes with the proper functioning of the dryer's airflow. If the dripping water continues to flow into the heating element located below the duct, it could lead to short circuits or electrical leakage in the internal electrical components, resulting in malfunction or even safety hazards.

In view of this, in-depth and extensive researches and improvement efforts have been made to address these issues and thereby resulting in the present invention.

### BRIEF SUMMARY OF THE INVENTION

The present invention aims to provide an improved structure for a dryer duct, which prevents water droplets from flowing into the air intake channel of the duct while the duct is working, ensuring the proper functioning of the duct.

In order to achieve the above objectives, the present invention adopts the following solutions:

A duct of a dryer, wherein a central part of the duct forms an air intake channel for introducing hot air; a top surface of the duct extends forward to form a top baffle; the top baffle is positioned above the air intake channel, and an air outlet of the air intake channel is positioned on an outer wall of the air intake channel; the air outlet is positioned below the top baffle.

Further, a front end of the top baffle also extends downwardly to form an overhang.

Further, a lower baffle positioned below the top baffle is further provided as a side wall of the duct; the lower baffle extends outwardly from a position below the air outlet; at least one drainage hole is formed on the lower baffle.

Further, a water-permeable gap is formed between a rear end of the lower baffle and the outer wall of the air intake channel; the air outlet is positioned above the water-permeable gap; water dripped on the lower baffle flows out through the water-permeable gap and then flow down along the outer wall of the air intake channel.

Further, the air outlet is positioned above the water-permeable gap; a flow guide channel is positioned on an outer wall of the duct and below the lower baffle; the water-permeable gap is positioned above the flow guide channel.

Further, side baffles are provided respectively on two side surfaces between the top baffle and the lower baffle, and each side baffle extends downward from a side edge of the top baffle to a corresponding side of the lower baffle.

Further, the top baffle and the lower baffle are inclined, wherein higher ends of the top baffle and the lower baffle are defined as front ends respectively.

Further, at least one flow guide channel independent from the air intake channel is provided on an outer wall of the duct or inside the duct; the top baffle is positioned above the flow guide channel.

Further, at least one upper opening is formed on an upper portion of the flow guide channel, and a lower opening is formed at a lower end of the flow guide channel; the lower opening is positioned at a lower end of the duct; said at least one upper opening is positioned below the air outlet.

Further, a side vent area is further formed on a side surface of the duct; the side vent area is in communication with the air intake channel, and the side vent area is recessed from the outer wall of the duct; a plurality of downwardly inclined air outlet slots are formed on the recessed wall area.

Further, at least one supporting rib is further provided on the top baffle.

By adopting the structures described above where a top baffle is provided on top of the duct, and the top baffle covers the air intake channel, the air outlet and the flow guide channel to prevent dripping water from dripping or flowing into the air intake channel of the duct when the duct is operating. Also, a lower baffle which can guide the flow of water dropped on it is provided below the top baffle so as to prevent water from entering into the duct. Accordingly, the dryer can be ensured to operate as usual and is safer to use.

### BRIEF DESCRIPTION OF THE DRAWINGS

FIG. 1 is a schematic diagram of the present invention used with a dryer;

FIGS. 2 and 3 are schematic diagrams of the three-dimensional structure of the present invention;

FIG. 4 is a front view of the present invention;

FIG. 5 is a side view of the present invention;

FIG. 6 is a bottom view of the present invention; and

FIG. 7 is a structural schematic diagram of a longitudinal section of the present invention.

### DESCRIPTION OF REFERENCE NUMERALS

1 represents a base, 2 represents a lower tube, 3 represents a duct,
31 represents an air intake channel, 311 represents an air outlet, 32 represents a flow guide channel,
321 represents an upper opening, 322 represents a lower opening, 33 represents a top baffle,
331 represents an overhang, 34 represents a lower baffle, 341 represents a drainage hole,
342 represents a water-permeable gap, 35 represents a side baffle, 36 represents a supporting rib,
37 represents a side vent area, 371 represents an recessed wall area, and 372 represents an air outlet slot.

### DETAILED DESCRIPTION OF THE INVENTION

In order to further explain the technical solutions of the present invention, the present invention will be explained in detail by the specific embodiments.

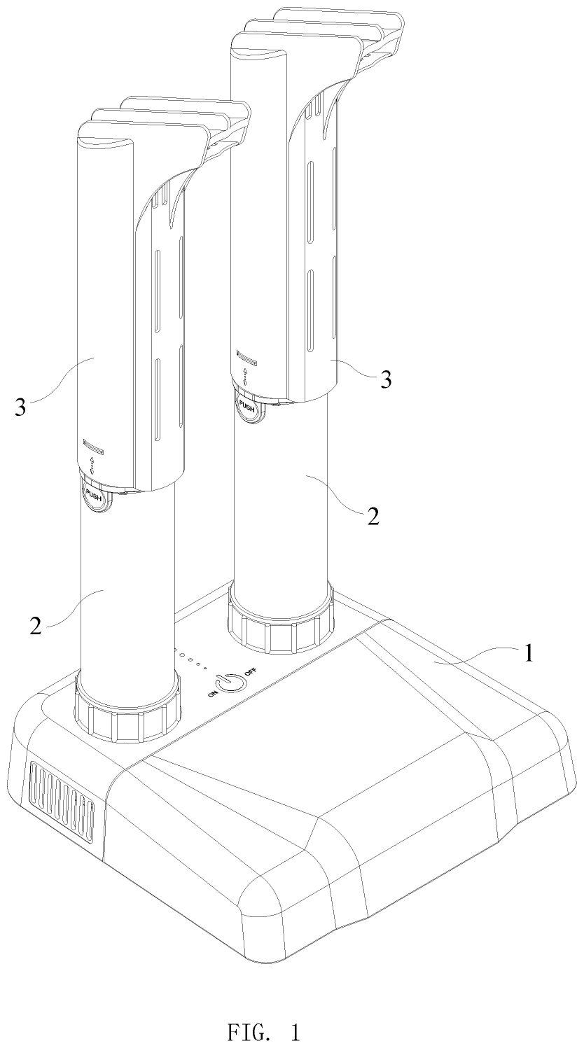

The present invention discloses an improved structure for a duct of a dryer. An exemplary embodiment of the dryer is shown in FIG. 1, the dryer may comprise a base 1 with at least one heating pipe installed thereon. In this embodiment, two heating pipes are provided. Elements such as a heater and a fan (not shown in the figure) may be provided in the base 1, where the heater generates hot air, which is then blown out through the heating pipes by the fan. Each of the heating pipes in this embodiment comprises a lower tube 2 and a duct 3 movably sleeving the lower tube 2. The duct 3 serves as an air outlet. Each of the lower tubes 2 is fixedly mounted on the base 1, and the duct 3 movably sleeves the corresponding lower tube 2 to control a length of the corresponding heating pipe. Specifically, each lower tube 2 is slidably sleeved by a corresponding duct 3 to form a telescopic heating pipe. In this embodiment. The ducts 3 of the dryer can be used not only for drying shoes, but also for drying helmets, socks, gloves, and other items prone to damp. The improvement of the present invention lies in the ducts 3, and so the structural aspects of the dryer are not within the protection scope of the present invention. Therefore, further details of the dryer itself will not be described in detail herein.

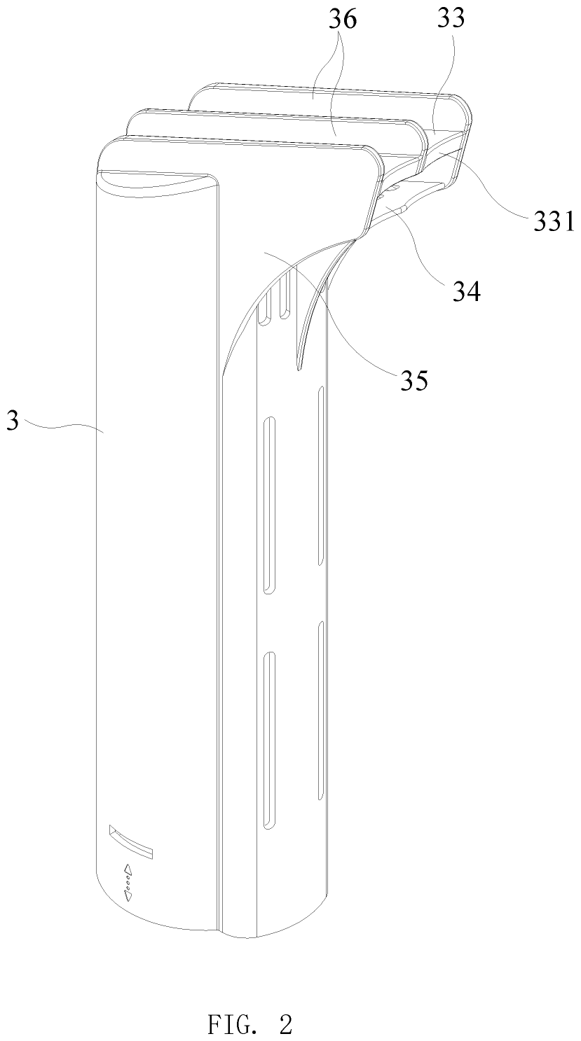

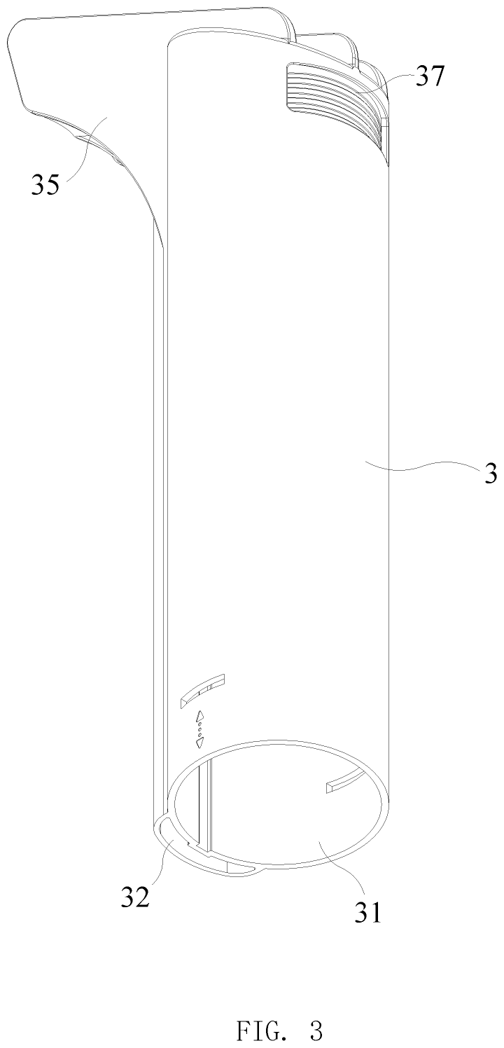

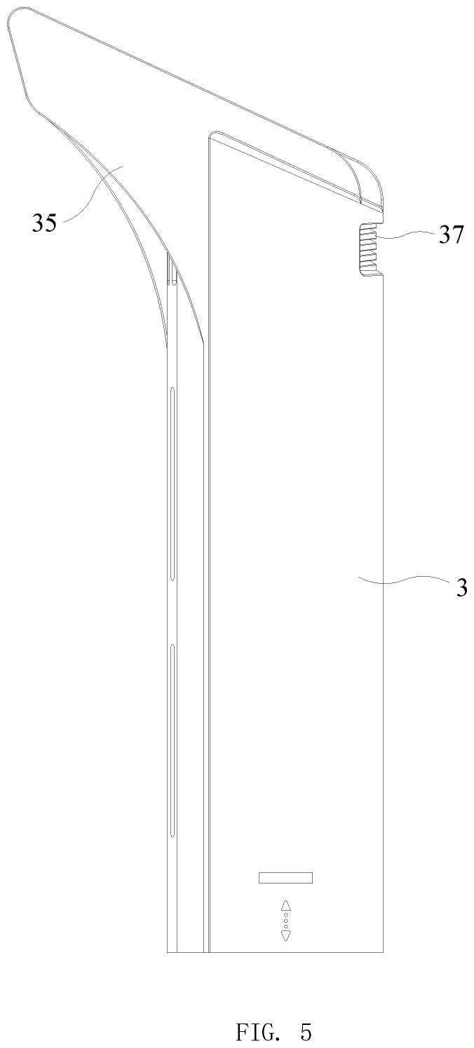

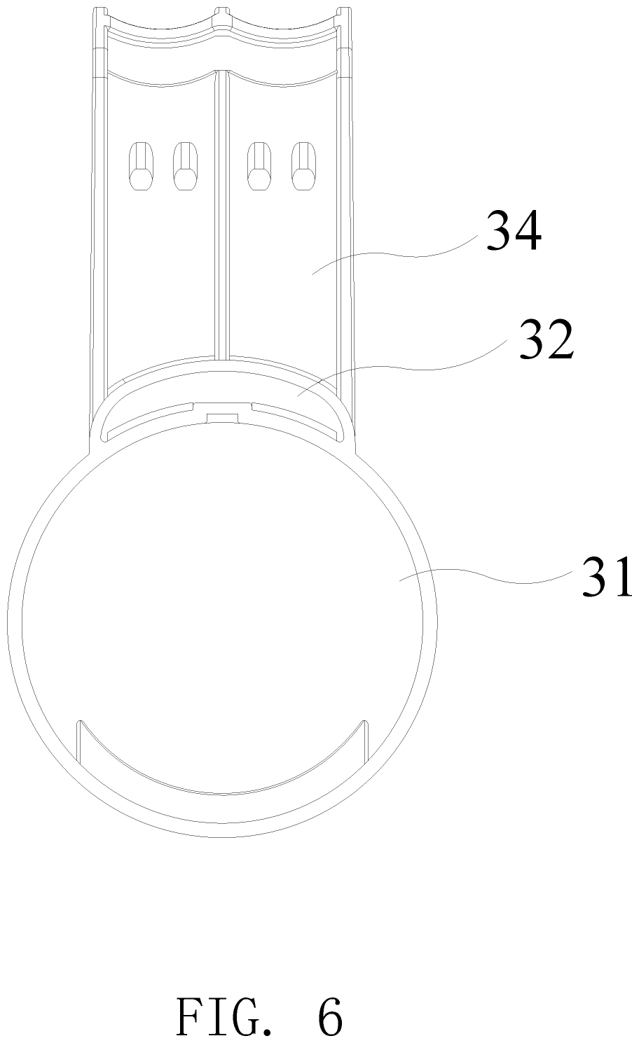

Referring to FIGS. 2 to 7, in each of the ducts 3, a central part of the duct 3 forms an air intake channel 31 for introducing hot air. In the present invention, to prevent dripping water from entering an interior of the duct 3 when the duct 3 is inserted into an item to be dried during the drying process, an air outlet 311 of the air intake channel 31 is positioned on an outer wall of the air intake channel 31 at a position proximal to an upper end of the air intake channel 31. Hot air is discharged from the air outlet 311 after passing through the air intake channel 31. For instance, when the duct 3 is inserted into a shoe, hot air can be blown into an interior of the shoe for drying. Further, a top surface of the duct 3 is a sealed surface formed by a top baffle 33 on top of the air intake channel 31 covering the air intake channel 31, and the top baffle 33 further extends beyond the air intake channel 31 such that the air outlet 311 is also positioned below the top baffle 33. With the aforementioned structure, when the duct 3 is inserted into a shoe, hot air is blown out from the air outlet 311 below the top baffle 33, and the hot air disperses outwardly to dry an inner cavity of the shoe. Due to the shielding effect of the top baffle 33, it prevents dripping water from directly falling into the air intake channel 31 and interfering with proper airflow and drying during the drying process.

In this embodiment, at least one flow guide channel 32 independent from the air intake channel 31 is provided on an outer wall of the duct 3 or inside the duct, and also, the top baffle 33 is positioned above the flow guide channel 32. By providing the flow guide channel 32, when the duct 3 is used for hot drying, the flow guide channel 32 can prevent air blockage inside the shoe or an inner cavity of any item to be dried which may otherwise lead to backflow of hot air, stagnant air and the lack of airflow circulation inside the shoe or the inner cavity of an item to be dried which may otherwise result in inefficient air circulation and low efficiency in drying, as well as damage to and malfunction of the dryer due to backflow of hot air which would easily cause deformation of the fan inside the dryer because of overheating.

Further, a front end of the top baffle 33 extended beyond the air intake channel may also extend downwardly to form an overhang 331. The overhang 331 prevents dripping water on top of the top baffle 33 from flowing along the surfaces of the top baffle 33 and particularly running along a bottom surface of the top baffle 33. With the overhang 331, the dripping water can drip downwardly along the overhang 331.

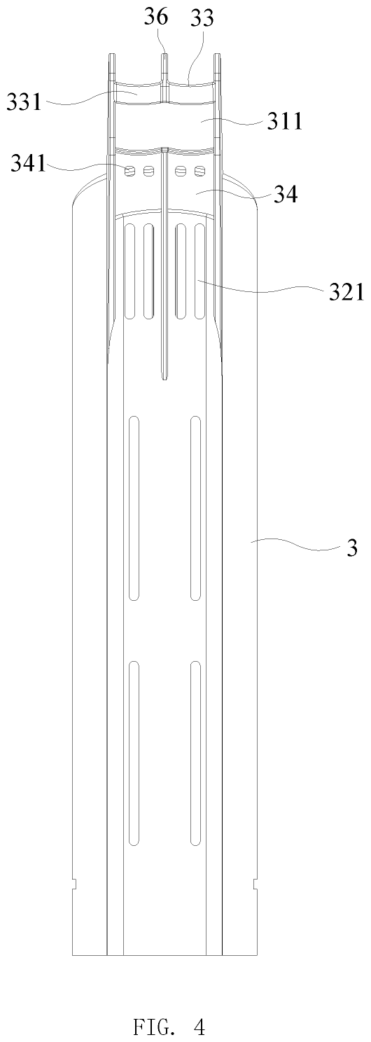

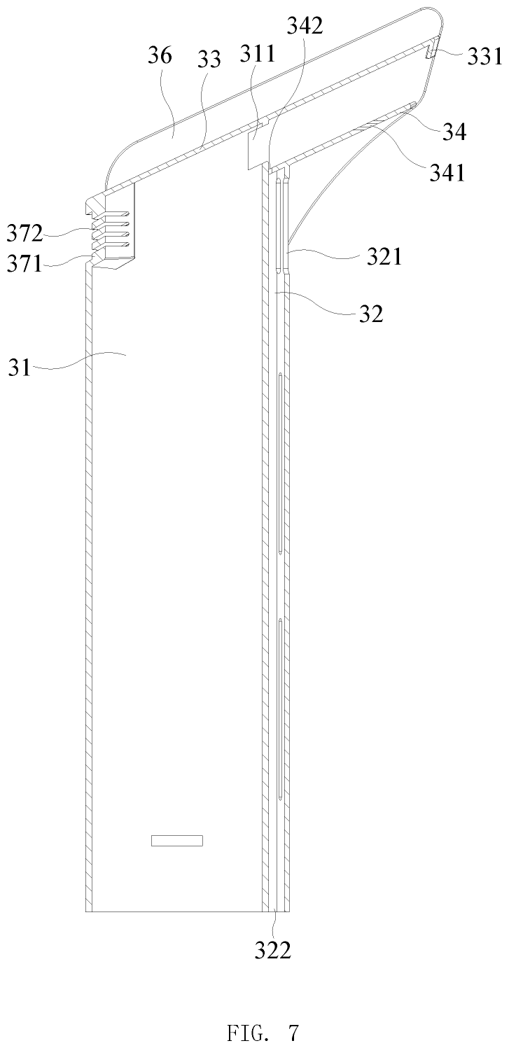

To further prevent water at a front end of the duct 3 from entering the air outlet 311, a lower baffle 34 positioned below the top baffle 33 is further provided as a side wall of the duct 3; the lower baffle 34 extends outwardly from the air outlet 311 below the air outlet 311; an air outlet channel positioned at a front end of the air outlet 311 is formed between the top baffle 33 and the lower baffle 34. To facilitate drainage, at least one drainage hole 341 is formed on the lower baffle 34. This allows dripping water (coming down from the overhang 331, or dripped down from outside the duct) to directly drain out through the drainage hole 341 after falling onto the lower baffle 34, thereby effectively discharging the dripping water out of the duct. The lower baffle 34 can thus serve as a flow guide to guide water flow in the air outlet channel. Further, a water-permeable gap 342 may be formed between a rear end of the lower baffle 34 and the outer wall of the air intake channel 31, and water dripped on the lower baffle 34 can flow out through the water-permeable gap 342 and then flow down along the outer wall of the air intake channel 31. As shown in FIG. 7, the air outlet 311 is positioned above the water-permeable gap 342. The air outlet 311 forms an opening on the outer wall of the air intake channel 31, and a portion of the outer wall of the air intake channel 31 between a lower end of the air outlet and the water-permeable gap 342 forms a barrier to prevent water from the lower baffle 34 from entering the air intake channel 31 which may otherwise affect the air outlet process and cause potential safety hazards from water dripping into the duct. In this embodiment, when the flow guide channel 32 is positioned on the outer wall of the duct 3 and below the lower baffle 34, the water-permeable gap 342 is positioned above the flow guide channel 32, allowing water to flow into the flow guide channel 32 and thus be discharged. As said, the flow guide channel 32 is an independent channel provided on the outer wall of the duct 3 or inside the duct. In this embodiment, the flow guide channel 32 is formed by a space enclosed by the outer wall of the duct 3 and the outer wall of the air intake channel 31. At least one upper opening 321 is formed on an upper portion of the flow guide channel 32, and a lower opening 322 is formed at a lower end of the flow guide channel, and the lower opening 322 at the lower end of the flow guide channel may be positioned at a lower end of the duct 3. In this embodiment, the flow guide channel 32 is positioned on the outer wall of the duct 3, and said at least one upper opening 321 may be embodied as a plurality of openings on an outer wall of the flow guide channel 32 (as shown in FIG. 4) above the lower end of the flow guide channel. The upper opening 321 is positioned below the air outlet 311 and positioned below the lower baffle 34. Alternatively, the flow guide channel 32 may also be an independent channel positioned inside the duct 3, with the upper opening thereof positioned inside the air intake channel 31 and below the air outlet 311.

For better drainage of the dripping water, in this embodiment, the top baffle 33 and the lower baffle 34 are inclined, with higher ends of the top baffle 33 and the lower baffle 34 defined as front ends, thereby allowing water to flow backward from the front end of the duct 3. Also, side baffles 35 may be provided respectively on two side surfaces between the top baffle 33 and the lower baffle 34, and each side baffle 35 extends downward from a side edge of the top baffle 33 to a corresponding side of the lower baffle 34. The side baffles 35 can form barrier surfaces on both sides of the air outlet 311, forming a passage between the top baffle 33, the lower baffle 34 and the side baffles 35. This allows for a more rapid and precise flow of hot air to the toe area of the shoe to dry the shoe and then the hot air is smoothly discharged through the flow guide channel 32, thus improving the drying efficiency. Further, at least one supporting rib 36 may be further provided on the top baffle 33. In this embodiment, a supporting rib 36 is provided at a middle part of the top baffle 33, and upper edges of the two side baffles 35 at two side edges of the top baffle 33 can extend upward to form another two supporting ribs 36. When a shoe is placed over the duct 3, the supporting ribs 36 can create a supporting space above the duct 3, keeping the inner surface of the shoe away from the duct and forming a thermally conductive space.

Furthermore, to increase the discharge quantity of air, expand the air outlet area, and enhance drying efficiency, a side vent area 37 is further formed on a side surface of the duct 3. The side vent area 37 is in communication with the air intake channel 31, and the side vent area 37 is recessed from the outer wall of the duct 3 to prevent water from entering. In this embodiment, the side vent area 37 comprises a recessed wall area 371 formed proximal to an upper end of the outer wall of the duct. A plurality of downwardly inclined air outlet slots 372 are formed on the recessed wall area 371, the air outlet slots 372 are also recessed from the outer wall of the duct 3, and the air outlet slots 372 are inclined downwardly from an interior of the duct 3 to the outer wall of the duct 3. Specifically, the air outlet slots 372 are formed by providing spacing strips on the recessed wall area, and the air outlet slots 372 are formed between the spacing strips. The spacing strips are inclined, or only upper surfaces of the spacing strips are inclined, thus preventing water flowing down from the top of the duct 3 from flowing into the air outlet slots 372, instead, water can flow outwardly from the air outlet slots without flowing into the side vent area 37. With the side vent area 37 positioned on the recessed wall area of the outer wall of the duct 3 and rows of the air outlet slots 372 arranged from top to bottom in the side vent area 37, water flowing down from the upper surface of the top baffle 33 can smoothly flow out along the outwardly and downwardly inclined air outlet slots 372, and will not be guided to flow into the air intake channel 31. Yet, some of the hot air can still be discharged outward through these air outlet slots 372 to dry the heel area of the shoes, thereby achieving comprehensive and rapid drying of the entire shoe.

The above embodiments and drawings are not intended to limit the form and style of the product of the present invention, and any suitable changes or modifications made by those of ordinary skill in the art shall fall within the patent scope of the present invention.

What is claimed is:

1. A duct of a dryer, wherein a central part of the duct forms an air intake channel for introducing hot air; a top surface of the duct extends forward to form a top baffle; the top baffle is positioned above the air intake channel, and an air outlet of the air intake channel is positioned on an outer wall of the air intake channel; the air outlet is positioned below the top baffle.

2. The duct of claim 1, wherein a front end of the top baffle also extends downwardly to form an overhang.

3. The duct of claim 1, wherein a lower baffle positioned below the top baffle is further provided as a side wall of the duct; the lower baffle extends outwardly from a position below the air outlet; at least one drainage hole is formed on the lower baffle.

4. The duct of claim 3, wherein a water-permeable gap is formed between a rear end of the lower baffle and the outer wall of the air intake channel; the air outlet is positioned above the water-permeable gap; water dripped on the lower baffle flows out through the water-permeable gap and then flow down along the outer wall of the air intake channel

5. The duct of claim 3, wherein side baffles are provided respectively on two side surfaces between the top baffle and the lower baffle, and each side baffle extends downward from a side edge of the top baffle to a corresponding side of the lower baffle.

6. The duct of claim 3, wherein the top baffle and the lower baffle are inclined, wherein higher ends of the top baffle and the lower baffle are defined as front ends respectively.

7. The duct of claim 1, wherein at least one flow guide channel independent from the air intake channel is provided on an outer wall of the duct; the top baffle is positioned above the flow guide channel.

8. The duct of claim 7, wherein at least one upper opening is formed at an upper portion of the glow guide channel, and a lower opening is formed at a lower end of the flow guide channel; the lower opening is positioned at a lower end of the duct;
said at least one upper opening is positioned below the air outlet.

9. The duct of claim 1, wherein a side vent area is further formed on a side surface of the duct; the side vent area is in communication with the air intake channel, and the side vent area is recessed from an outer wall of the duct; a plurality of downwardly inclined air outlet slots are formed on the recessed wall area.

10. The duct of claim 1, wherein at least one supporting rib is further provided on the top baffle.
